(19) United States
(12) Patent Application Publication
(10) Pub. No.: US 2021/0086765 A1
(43) Pub. Date: Mar. 25, 2021

(54) METHOD FOR DRIVING A MOTOR VEHICLE SAFELY IN AT LEAST PARTIALLY AUTOMATED FASHION

(71) Applicant: Robert Bosch GmbH, Stuttgart (DE)

(72) Inventors: Stefan Nordbruch, Kornwestheim (DE); Michael Gabb, Gaeufelden (DE)

(21) Appl. No.: 17/018,454

(22) Filed: Sep. 11, 2020

(30) Foreign Application Priority Data
Sep. 23, 2019 (DE) 102019214482.9

(51) Int. Cl. B60W 30/09; B60W 50/023; B60W 30/095; B60W 40/04

(52) U.S. Cl. CPC B60W 30/09; B60W 50/023; B60W 2554/404; B60W 40/04; B60W 2555/20; B60W 30/0956

(57) ABSTRACT

A method for driving a motor vehicle safely in at least partially automated fashion. The method includes the following steps: receiving infrastructure data signals, which represent infrastructure data generated by an infrastructure outside the motor vehicle, receiving safety condition signals, which represent at least one safety condition for driving the motor vehicle in at least partially automated fashion based on the infrastructure data, checking whether the at least one safety condition is fulfilled, ascertaining control commands for safely controlling a lateral and/or longitudinal guidance of the motor vehicle based on the infrastructure data as a function of a result of the check whether the at least one safety condition is fulfilled in order to drive the motor vehicle in at least partially automated fashion, generating control signals, which represent the ascertained control commands, outputting the generated control signals.

### CROSS REFERENCE

The present application claims the benefit under 35 U.S.C. § 119 of German Patent Application No. DE 102019214482.9 filed on Sep. 23, 2019, which is expressly incorporated herein by reference in its entirety.

### FIELD

The present invention relates to a method for driving a motor vehicle safely in at least partially automated fashion. The present invention further relates to a device, to a motor vehicle, to a computer program and to a machine-readable storage medium.

### BACKGROUND INFORMATION

German Patent Application No. DE 10 2017 204 603 A1 describes a vehicle control system and a method for controlling a vehicle.

German Patent Application No. DE 10 2018 124 807 A1 describes a system and a method for operating a hybrid drive train of a vehicle.

German Patent Application No. DE 10 2017 212 227 A1 describes a method and a system for vehicle data collection and vehicle control in road traffic.

Motor vehicles, which use data from an infrastructure, use these data for example for warning functions, information functions and comfort functions.

When infrastructure data are used for driving a motor vehicle in at least partially automated fashion, it should be ensured for example that the infrastructure data were not manipulated, for example.

### SUMMARY

An object of the present invention is to provide an efficient way for driving a motor vehicle safely in at least partially automated fashion.

This object may be achieved in accordance with example embodiments of the present invention. Advantageous developments of the present invention are described herein.

According to a first aspect of the present invention, a method is provided for driving a motor vehicle safely in at least partially automated fashion. In accordance with an example embodiment of the present invention, the method includes the following steps:

receiving infrastructure data signals, which represent infrastructure data generated by an infrastructure outside the motor vehicle,

receiving safety condition signals, which represent at least one safety condition for driving the motor vehicle in at least partially automated fashion based on the infrastructure data, checking whether the at least one safety condition is fulfilled, ascertaining control commands for safely controlling a lateral and/or longitudinal guidance of the motor vehicle based on the infrastructure data as a function of a result of the check whether the at least one safety condition is fulfilled in order to drive the motor vehicle in at least partially automated fashion,

generating control signals, which represent the ascertained control commands,

outputting the generated control signals.

According to a second aspect of the present invention, a device is provided, which is designed to perform all steps of the method according to the first aspect.

According to a third aspect of the present invention, a motor vehicle is provided, which comprises the device according to the second aspect.

According to a fourth aspect of the present invention, a computer program is provided, which comprises commands, which prompt a computer, for example the device according to the second aspect, when executing the computer program, to implement a method according to the first aspect.

According to a fifth aspect of the present invention, a machine-readable storage medium is provided, on which the computer program according to the third aspect is stored.

In accordance with example embodiments of the present invention, before infrastructure data are used for driving the motor vehicle in at least partially automated fashion, a check is performed to determine whether or not at least one safety condition is fulfilled. Based on this result, the control commands for safely controlling a lateral and/or longitudinal guidance of the motor vehicle are ascertained in order to drive the motor vehicle in at least partially automated fashion.

Thus, it is advantageously possible to ensure in an efficient manner that it is possible to control the lateral and/or longitudinal guidance safely based on the infrastructure data.

That is to say that the motor vehicle may thus be driven safely in at least partially automated fashion. Via the safety condition, it is thus possible to specify and/or determine or define a context, within which it is safe to control a lateral and/or longitudinal guidance of the motor vehicle based on the infrastructure data.

This yields in particular the technical advantage of minimizing or avoiding a risk for road users in the surroundings of the motor vehicle. This advantageously makes it possible to ensure in particular that a risk for the motor vehicle itself can be minimized or avoided.

In the sense of the description, “safe” means in particular “safe” and “secure.” These two English terms are normally translated into German as “sicker.” In English, however, they have in part a different meaning.

The term “safe” pertains in particular to the topic of accident and accident avoidance. A control of the lateral and/or longitudinal guidance of the motor vehicle based on the infrastructure data that is “safe” is one in which a probability of an accident and/or a collision is smaller than or smaller than/equal to a predetermined probability threshold value.

The term “secure” pertains in particular to the topic of computer protection and/or hacker protection, that is, in particular to how well a (computer) infrastructure and/or a communication infrastructure, in particular a communication link between a motor vehicle and a device according to the second aspect, is secured against unauthorized access and/or against data manipulations by third parties (“hackers”).

A control of the lateral and/or longitudinal guidance of the motor vehicle based on the infrastructure data that is “secure” is thus in particular based on an appropriate and sufficient computer protection and/or hacker protection.

A technical advantage is thus produced of providing an efficient way for driving a motor vehicle safely in at least partially automated fashion.

The formulation “driving in at least partially automated fashion” comprises one or several of the following cases: assisted driving, partially automated driving, highly automated driving, fully automated driving.

Assisted driving means that a driver of the motor vehicle permanently performs either the lateral or the longitudinal guidance of the motor vehicle. The respectively other driving task (that is, controlling the longitudinal or the lateral guidance of the motor vehicle) is performed automatically. That is to say that in assisted driving of the motor vehicle either the lateral guidance or the longitudinal guidance is controlled automatically.

Partially automated driving means that in a specific situation (for example: driving on a freeway, driving within a parking facility, passing an object, driving within a traffic lane, which is defined by lane markers) and/or for a certain time period a longitudinal guidance and a lateral guidance of the motor vehicle are controlled automatically. It is not necessary for a driver of the motor vehicle to control the longitudinal and lateral guidance of the motor vehicle manually. Nevertheless, the driver must permanently monitor the automatic control of the longitudinal and lateral guidance so as to be able to intervene manually when necessary. The driver must always be prepared to take complete control of driving the motor vehicle.

Highly automated driving means that for a certain time period in a specific situation (for example: driving on a freeway, driving within a parking facility, passing an object, driving within a traffic lane, which is defined by lane markers) a longitudinal guidance and a lateral guidance of the motor vehicle are controlled automatically. It is not necessary for a driver of the motor vehicle to control the longitudinal and lateral guidance of the motor vehicle manually. It is not necessary for the driver permanently to monitor the automatic control of the longitudinal and lateral guidance so as to be able to intervene manually when necessary. When necessary, a takeover request is automatically output to the driver for taking over the control of the longitudinal and lateral guidance, in particular with sufficient time to respond. Thus, the driver must be potentially able to take control of longitudinal and lateral guidance. Limits of the automatic control of the lateral and longitudinal guidance are detected automatically. In highly automated driving, it is not possible in every initial situation to bring about a risk-minimized state automatically.

Fully automated driving means that in a specific situation (for example: driving on a freeway, driving within a parking facility, passing an object, driving within a traffic lane, which is defined by lane markers) a longitudinal guidance and a lateral guidance of the motor vehicle are controlled automatically. It is not necessary for a driver of the motor vehicle to control the longitudinal and lateral guidance of the motor vehicle manually. It is not necessary for the driver to monitor the automatic control of the longitudinal and lateral guidance so as to be able to intervene manually when necessary. Prior to a termination of the automatic control of the lateral and longitudinal guidance, a request is automatically output to the driver to take over the task of driving (controlling the lateral and longitudinal guidance of the motor vehicle), in particular with sufficient time to respond. If the driver does not take over the task of driving, the motor vehicle is automatically returned to a risk-minimized state. Limits of the automatic control of the lateral and longitudinal guidance are detected automatically. In all situations it is possible to return the motor vehicle automatically to a risk-minimized system state.

One specific embodiment of the present invention provides that, if the at least one safety condition is not fulfilled, the ascertaining of the control commands comprises at least one securing step for ensuring that the lateral and/or longitudinal guidance of the motor vehicle may be controlled safely on the basis of the control commands.

This may yield, for example, the technical advantage that the control commands are safe even in the event that the at least one safety condition is not fulfilled.

One specific embodiment of the present invention provides for the at least one securing steps to be respectively selected from the following group of securing steps: redundant processing, in particular computing, of data, diversitary processing, in particular computing, of data, checking an operability of a redundant component for controlling the lateral and/or longitudinal guidance of the motor vehicle.

This yields for example the technical advantage of allowing the use of particularly suitable securing steps.

One specific embodiment of the present invention provides that, if the infrastructure data comprise a drive specification, which the motor vehicle is to follow by driving in at least partially automated fashion, the drive specification is checked to determine whether it is safe by using data generated within the vehicle and/or by using at least one algorithm provided within the vehicle, the control commands being ascertained as a function of a result of the check determining whether the drive specification is safe.

This may yield, for example, the technical advantage of allowing the motor vehicle to be driven particularly safely in at least partially automated fashion.

One specific embodiment of the present invention provides that, if the infrastructure data comprise further data in addition to the drive specification, in particular environment sensor data of at least one infrastructure environment sensor, the check whether the drive specification is safe is performed additionally based on the further data.

This may yield, for example, the technical advantage of allowing the check to be performed in an efficient manner.

Data generated within the motor vehicle may also be referred to as motor vehicle data, for example.

In one specific embodiment of the present invention, motor vehicle data are provided or motor vehicle data are furnished.

One specific embodiment of the present invention provides for the motor vehicle data to comprise respectively an element selected from the following group of motor vehicle data: drive planning data, position data, speed data, environment sensor data of an environment sensor of the motor vehicle, diagnostic data, environment model of a surroundings of the motor vehicle, route data, weather data, which represent a weather in a surroundings of the motor vehicle, traffic data, which represent a traffic in a surroundings of the motor vehicle, hazard data, which represent a location and/or a type of a hazard area in the surroundings of the motor vehicle, road user state data, which represent a state of a road user in the surroundings of the motor vehicle.

This may yield, for example, the technical advantage of allowing the use of particularly suitable motor vehicle data.

One specific embodiment of the present invention provides for the control commands for safely controlling a lateral and/or longitudinal guidance of the motor vehicle to be ascertained on the basis of motor vehicle data (that is, in particular in addition to being ascertained on the basis of the infrastructure data).

One specific embodiment of the present invention provides for the at least one safety condition to be respectively an element selected from the following group of safety conditions: existence of a confirmation of the infrastructure that the infrastructure data are secure,

existence of a predetermined safety integrity level (SIL) or automotive safety integrity level (ASIL) of at least the motor vehicle and the infrastructure, in particular including a communication link and/or communication components, in particular with respect to the overall systems in the motor vehicle and infrastructure and in particular parts, e.g. components, algorithms, interfaces, etc.,

existence of a maximum latency of a communication between the motor vehicle and the infrastructure,

existence of a predetermined computer protection level of a device according to the second aspect,

existence of predetermined components and/or algorithms and/or communication options that are used for performing the steps of the method according to the first aspect,

existence of a redundancy and/or diversity in predetermined components and/or algorithms and/or communication options that are used for performing the steps of the method according to the first aspect,

existence of predetermined availability information, which indicates an availability of predetermined components and/or algorithms and/or communication options,

existence of predetermined quality criteria of the predetermined components and/or algorithms and/or communication options,

existence of a plan which comprises measures for reducing errors and/or measures in the event of failures of predetermined components and/or algorithms and/or communication options and/or measures for fault analyses and/or measures in the event of misinterpretations,

existence of one or multiple fallback scenarios, existence of a predetermined function,

existence of a predetermined traffic situation, existence of a predetermined weather, maximally possible time for a respective performance and/or execution of a step or of multiple steps of the method according to the first aspect,

existence of a result of a check to determine that elements and/or functions, which are used for carrying out the method according to the first aspect, currently function in a faultless manner.

It is possible to ascertain safe control commands efficiently in particular if a confirmation of the infrastructure exists that the infrastructure data are secure.

A communication link is for example a communication link between the device according to the second aspect and the motor vehicle. A communication link comprises for example one or multiple communication channels.

In one specific embodiment of the present invention, a component, which is used to carry out the method according to the first aspect, is an element selected from the following group of components: environment sensor, motor vehicle, infrastructure, device according to the second aspect, motor vehicle system, in particular drive system, clutch system, brake system, driver assistance system, communication interface of the motor vehicle and/or of the infrastructure, processor, input, output of the device according to the second aspect, control unit, in particular main control unit of the motor vehicle.

A computer protection level defines in particular the following: activated firewall and/or valid encryption certificate for encrypting a communication between the motor vehicle and the infrastructure and/or activated virus program having updated virus signatures and/or existence of a protection, in particular a mechanical protection, in particular a break-in protection, of the computer, in particular of the device according to the second aspect, and/or existence of a possibility for checking that signals, in particular infrastructure data signals, were transmitted correctly, that is, error-free.

An algorithm comprises for example the computer program according to the third aspect.

The fact that in particular a check is performed to determine that there exists a redundancy and/or diversity in predetermined components and/or algorithms and/or communication options yields for example the technical advantage that even in the event of a failure of the respective component, for example a computer, and/or of the corresponding algorithm and/or of the corresponding communication option, it is nevertheless possible to control the lateral and/or longitudinal guidance of the motor vehicle safely.

To ensure that results are correct, it is possible in one specific embodiment of the present invention to calculate these results multiple times for example and to compare the respective results with one another. Only if there is agreement among the results is it determined for example that the results are correct. If multiple times is an uneven number, it may be provided for example that a determination is made that the result corresponding to the highest number of identical results is correct.

One specific embodiment of the present invention provides for a control of the lateral and/or longitudinal guidance of the motor vehicle based on the output control signals to be monitored in that the step of checking whether the at least one safety condition is fulfilled is performed anew, the control of the lateral and/or longitudinal guidance of the motor vehicle based on the output control signals being continued to be executed as a function of a new result with respect to whether the at least one safety condition is fulfilled.

This yields for example the technical advantage that controlling the lateral and/or longitudinal guidance of the motor vehicle based on the infrastructure data may be monitored efficiently.

If the renewed check should yield the result for example that the at least one safety condition is no longer fulfilled, the control of the lateral and/or longitudinal guidance of the motor vehicle based on the infrastructure data is aborted for example.

If the renewed check yields the result for example that the at least one safety condition continues to be fulfilled, the control of the lateral and/or longitudinal guidance of the motor vehicle based on the infrastructure data is continued for example.

One specific embodiment of the present invention provides for one or multiple method steps to be performed within the vehicle and/or one or multiple method steps to be performed outside the vehicle, in particular in the infrastructure and/or in particular in a cloud infrastructure.

This yields for example the technical advantage of allowing the corresponding method steps to be performed redundantly in an efficient manner. In particular, this may advantageously further increase a safety.

One specific embodiment of the present invention provides for one or multiple method steps to be documented, in particular documented in a blockchain.

This may yield, for example, the technical advantage of allowing the method to be analyzed even after its implementation or execution, on the basis of the documentation. The documentation in a blockchain in particular has the technical advantage that the documentation is secured against manipulation and forgery.

A blockchain (also block chain) is a continuously expandable list of data sets, called “blocks”, which are linked to one another by one or multiple cryptographic methods. Each block contains in particular a cryptographically secure hash (erratic value) of the preceding block, in particular a time stamp and in particular transaction data.

One specific embodiment of the present invention provides for a check to be performed to determine whether a totality made up of the motor vehicle and of infrastructure involved in the method according to the first aspect including a communication between infrastructure and motor vehicle is secure so that the motor vehicle and/or a local and/or a global infrastructure and/or a communication between motor vehicle and infrastructure are checked accordingly.

That is to say in particular that the components used in the implementation of the method according to the first aspect are checked for safety, that is, whether they fulfill specific safety conditions, before the lateral and/or longitudinal guidance of the motor vehicle may be controlled using and/or based on the infrastructure data.

Important and/or dependent criteria are for example one or several of the safety conditions described above.

One specific embodiment of the present invention provides for the infrastructure data to comprise one or several elements selected from the following group of data: environment sensor data of an infrastructure environment sensor, surroundings data, which represent a surroundings of the motor vehicle, weather data, which represent a weather in a surroundings of the motor vehicle, traffic data, which represent a traffic in a surroundings of the motor vehicle, hazard data, which represent a location and/or a type of a hazard area in the surroundings of the motor vehicle, road user state data, which represent a state of a road user in the surroundings of the motor vehicle, drive specification which the motor vehicle is to follow by driving.

This yields for example the technical advantage of allowing the use of particularly suitable infrastructure data.

Generally, an environment sensor in the sense of the description is one of the following environment sensors: radar sensor, lidar sensor, ultrasonic sensor, magnetic field sensor, infrared sensor and video sensor, in particular video sensor of a video camera.

One specific embodiment of the present invention provides for the device to check a drive specification only for a certain distance to determine whether it is safe. That is to say that if for example the drive specification should go over a first distance, then the safety check is performed only up to a second distance, this second distance being smaller than the first distance.

One specific embodiment of the present invention provides for the device to check a drive specification of the infrastructure, in particular only for a certain distance, only for accident avoidance, to determine whether an accident is avoided. That the device checks the drive specification of the infrastructure only for accident avoidance means in particular that the check takes into account only emergency measures (e.g. full braking), no comfort aspects in particular being taken into account.

That is to say in particular that the device checks the drive specification of the infrastructure up to the first distance only for accident avoidance, comfort aspects being disregarded for this purpose. That is to say that the drive specification of the infrastructure up to the first distance may result in an uncomfortable drive of the motor vehicle. Such a drive specification is nevertheless in particular implemented, as long as it avoids accidents.

One specific embodiment of the present invention provides for the method according to the first aspect to be a computer-implemented method.

One specific embodiment of the present invention provides for the method according to the first aspect to be carried out or implemented using the device according to the second aspect.

Device features result analogously from corresponding method features and vice versa. That is to say in particular that technical functionalities of the device according to the second aspect analogously result from corresponding technical functionalities of the method according to the first aspect and vice versa.

The formulation “at least one” stands in particular for “one or several.”

Exemplary embodiments of the present invention are illustrated in the figures and are explained in greater detail below.

### BRIEF DESCRIPTION OF THE DRAWINGS

FIG. 1 show a flow chart of a method for driving a motor vehicle safely in at least partially automated fashion in accordance with an example embodiment of the present invention.

FIG. 2 shows a device in accordance with an example embodiment of the present invention.

FIG. 3 show a machine-readable storage medium in accordance with an example embodiment of the present invention.

FIG. 4 show a motor vehicle in accordance with an example embodiment of the present invention.

FIGS. 5 to 13 respectively shown a motor vehicle in accordance with example embodiments of the present invention.

In the following text, the same reference numerals may be used for identical features.

### DETAILED DESCRIPTION OF EXAMPLE EMBODIMENTS

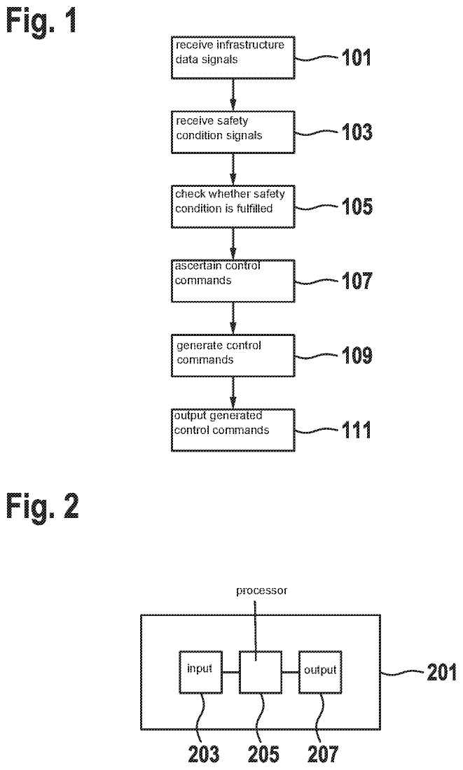

FIG. 1 shows a flow chart of a method for driving a motor vehicle safely in at least partially automated fashion, in accordance with an example embodiment of the present invention.

The method includes the following steps:

receiving 101 infrastructure data signals, which represent infrastructure data generated by an infrastructure outside the motor vehicle,

receiving 103 safety condition signals, which represent at least one safety condition for driving the motor vehicle in at least partially automated fashion based on the infrastructure data, checking 105 whether the at least one safety condition is fulfilled,

ascertaining 107 control commands for safely controlling a lateral and/or longitudinal guidance of the motor vehicle based on the infrastructure data as a function of a result of the check whether the at least one safety condition is fulfilled in order to drive the motor vehicle in at least partially automated fashion,

generating 109 control signals, which represent the ascertained control commands,

outputting 111 the generated control signals.

According to one specific embodiment of the present invention, the method according to the first aspect comprises controlling the lateral and/or longitudinal guidance of the motor vehicle based on the output control signals in order to drive the motor vehicle in at least partially automated fashion.

FIG. 2 shows a device 201 in accordance with an example embodiment of the present invention.

Device 201 is designed to perform all of the steps of the method according to the first aspect.

Device 201 comprises an input 203, which is designed to receive the infrastructure data signals and the safety condition signals.

Device 201 comprises a processor 205, which is designed to perform or execute the steps of checking, of ascertaining and of generating.

Device 201 further comprises an output 207, which is designed to output the generated control signals.

Device 201 is for example comprised by a motor vehicle.

Signals that are received are generally received via input 203. Input 203 is thus designed in particular to receive the respective signals.

Signals that are output are generally output via output 207. Output 207 is thus designed in particular to output the respective signals.

According to one specific embodiment, multiple processors are provided instead of the one processor 205.

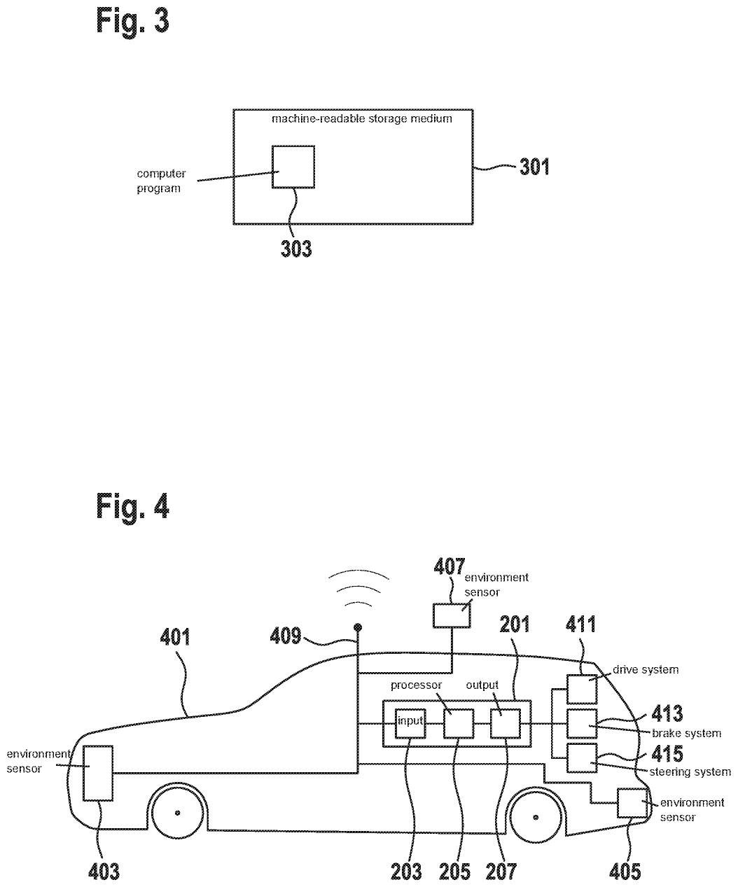

FIG. 3 shows a machine-readable storage medium 301 in accordance with an example embodiment of the present invention.

A computer program 303 is stored on machine-readable storage medium 301, which comprises commands that prompt a computer when executing computer program 303 to implement a method according to the first aspect.

FIG. 4 shows a motor vehicle 401 in accordance with an example embodiment of the present invention.

Motor vehicle 401 comprises the device 201 shown in FIG. 2.

Motor vehicle 401 comprises a first front-side environment sensor 403, a second rear-side environment sensor 405, and a third roof-side environment sensor 407.

Motor vehicle 401 further comprises a wireless communication interface 409.

Infrastructure data may be received via the wireless communication interface 409. These are provided to input 203 of device 201.

Furthermore, environment sensors 403, 405, 407 of a respective environment acquisition provide corresponding environment sensor data to input 203.

Output 207 then outputs accordingly generated control signals for example to a drive system 411 and/or a brake system 413 and/or a steering system 415 of motor vehicle 401 in order to drive motor vehicle in at least partially automated fashion.

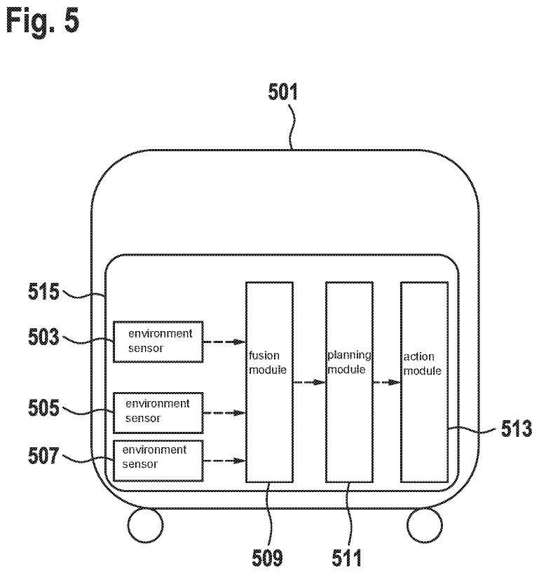

FIG. 5 shows another motor vehicle 501 in accordance with an example embodiment of the present invention.

According to a specific embodiment that is not shown, motor vehicle 501 comprises the device 201 as shown in FIG. 2 or generally a device according to the second aspect.

Motor vehicle 501 comprises a first environment sensor 503, a second environment sensor 505, and a third environment sensor 507.

In a specific embodiment that is not shown, more or fewer than three infrastructure sensors may be provided.

The environment sensor data of environment sensors 503, 505, 507 are provided to a fusion module 509. Fusion module 509 is designed to perform a fusion of the environment sensor data based on the environment sensor data. That is to say that the environment sensor data of the three environment sensors 503, 505, 507 are fused in fusion module 509.

On the basis of the fused environment sensor data, fusion module 509 is able to ascertain for example an environment model of a surroundings of motor vehicle 501.

The environment model or generally the fused environment sensor data are provided to a planning module 511.

Planning module 511 is designed for example to prepare a drive plan for motor vehicle 501 based on the environment model and/or on the fused environment sensor data. Planning module 511 plans for example one or multiple driving maneuvers, which motor vehicle 501 is to execute in at least partially automated fashion.

The planned driving maneuver is provided in an action module 513.

Action module 513 is designed to ascertain control commands for controlling a lateral and/or longitudinal guidance of the motor vehicle based on the planned driving maneuver in such a way that when the lateral and/or longitudinal guidance of the motor vehicle is controlled on the basis of the control commands, the motor vehicle performs or drives the planned driving maneuver in at least partially automated fashion.

The three modules 509, 511, 513 may be respectively implemented or realized for example as software and/or as hardware.

For example, these three modules 509, 511, 513 are implemented in processor 205 of device 201 and/or are executed by processor 205.

That is to say in particular that processor 205 of device 201 may be designed to fuse the environment sensor data and/or to generate a corresponding environment model, to plan corresponding driving maneuvers and to ascertain the corresponding control commands.

Environment sensors 503, 505, 507 and the three modules 509, 511, 513 are drawn within a square 515 that has rounded corners, which is to symbolize that these elements fulfill specific safety conditions so that the corresponding control commands are safely able to control the lateral and/or longitudinal guidance of the motor vehicle.

That is to say for example that these elements exhibit specific quality criteria and/or exhibit predetermined ASIL levels. That is to say in particular that these elements exhibit a predetermined safety integrity level.

Advantageously, this makes it in particular possible to ensure that the individual computations performed by the individual modules 509, 511, 513 provide correct results.

Thus it is possible, for example, advantageously to ensure that environment sensors 503, 505, 507 function reliably.

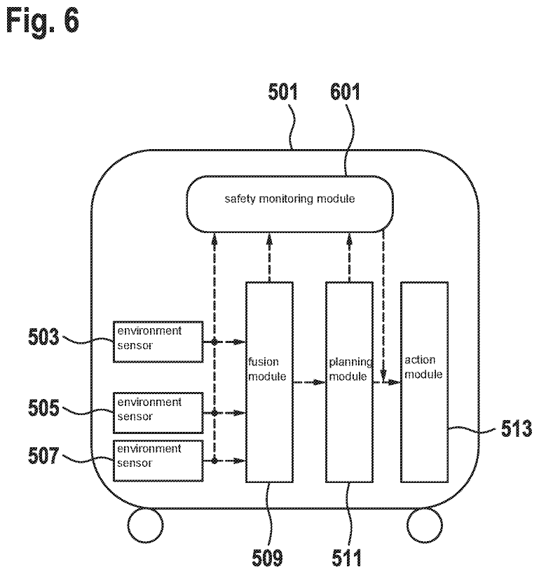

FIG. 6 shows motor vehicle 501 in accordance with an example embodiment of the present invention, no square 515 being drawn here, but rather a safety monitoring module 601 being provided, which ensures that even in the absence of certain quality criteria (hence no square 515) with respect to the individual elements, the ascertained control commands nevertheless control the longitudinal and/or lateral guidance of the motor vehicle safely.

Safety monitoring module 601 is thus designed in particular to perform or execute at least one securing step in order to ensure that the lateral and/or longitudinal guidance of the motor vehicle can be controlled safely on the basis of the control commands.

Safety monitoring module 601 performs for example redundant and/or diversitary computing steps.

There may be a provision for example for safety monitoring module 601 to fuse the environment sensor data once more and/or to plan corresponding driving maneuvers once more and/or once more, that is redundantly, to ascertain corresponding control commands.

If these redundant computations provide the same results or at least results that lie within a predetermined tolerance range as the individual modules 509, 511, 513, then it may be assumed that the computed results of modules 509, 511, 513 are correct, and accordingly the control commands may then be used for controlling the lateral and/or longitudinal guidance of the motor vehicle.

Otherwise, there is a provision for example for the individual modules 509, 511, 513 to repeat their respective computations.

One specific embodiment of the present invention may also provide for motor vehicle 501 to be stopped in the event of a deviating result or generally to be transferred into a safe state, it being possible to perform an emergency stop for example.

A specific embodiment of the present invention that is not shown provides for the individual elements to fulfill specific safety conditions as well, as is shown symbolically in FIG. 5 by the square 515 that has the rounded corners. At the same time, a safety monitoring module 601, as shown in FIG. 6, may also be provided.

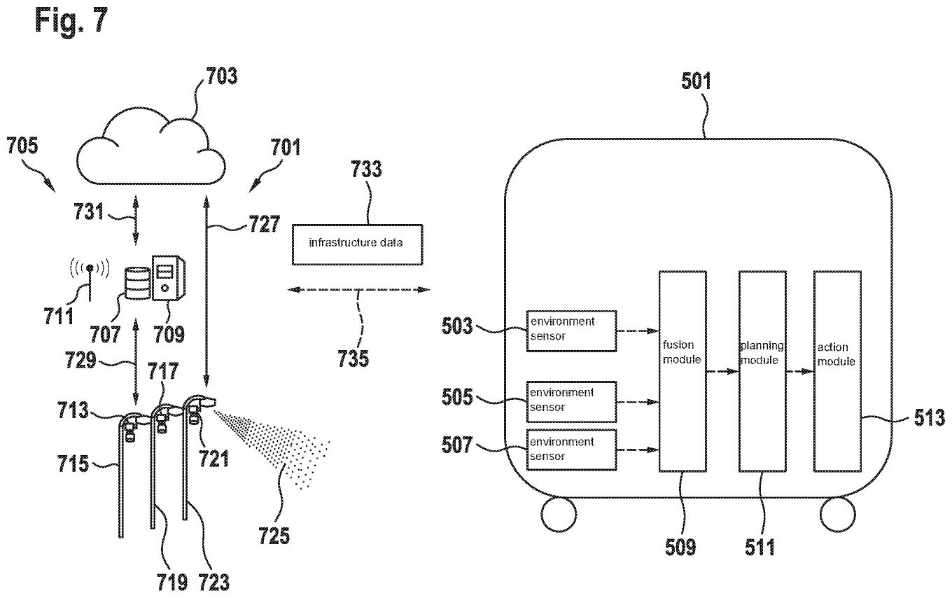

FIG. 7 shows motor vehicle 501 while being driven within an infrastructure 701 in at least partially automated fashion, in accordance with an example embodiment of the present invention.

Infrastructure 701 comprises a cloud infrastructure 703 and a local computer infrastructure 705. Local means in particular that this computer structure is spatially located within infrastructure 701, for example at a road, which is comprised by infrastructure 701 for example.

Computer infrastructure 705 comprises a database 707 and a computer 709 or multiple computers 709. Computer infrastructure 705 further comprises a wireless communication interface 711 and/or additionally or instead a wired communication interface.

Via this communication interface 711, local computer infrastructure 705 is able to communicate for example with motor vehicle 501 and/or with cloud infrastructure 703.

Infrastructure 701 further comprises a first video camera 713 comprising a video sensor (not shown), first video camera 713 being situated on a first street light 715.

A second video camera 717 comprising a video sensor (not shown) is situated on a second street light 719.

A third video camera 721 comprising a video sensor (not shown) is situated on a third street light 723. Third street light 723 emits light for example, which is indicated symbolically by a light cone having reference numeral 725.

The three street lights 715, 719, 723 are situated in spatially distributed fashion within infrastructure 701, in particular along a road, on which motor vehicle 501 is traveling.

Instead of or in addition to the three video cameras 713, 717, 721, radar sensors, ultrasonic sensors, lidar sensors and/or magnetic field sensors may also be provided.

Video cameras 713, 717, 721 communicate for example with local computer infrastructure 705 and with cloud infrastructure 703.

A respective communication between the three video cameras 713, 717, 721 and cloud infrastructure 703 is indicated symbolically by a first double arrow having reference numeral 727.

A communication between video cameras 713, 717, 721 and the local computer infrastructure 705 is indicated symbolically by a second double arrow having reference numeral 729.

A communication between the local computer infrastructure 705 and cloud infrastructure 703 is indicated symbolically by a third double arrow having reference numeral 731.

Infrastructure 701 may generate infrastructure data 733 for example and transmit these to motor vehicle 501, for example via a wireless communication network, for example a WLAN communication network and/or mobile telephony network.

That is to say in particular that infrastructure 701 is able to communicate with motor vehicle 501, which is represented symbolically by a fourth double arrow having reference numeral 735.

Infrastructure data 733 may comprise for example the environment sensor data of the video sensors of the three video cameras 713, 717, 721. For example, the raw environment sensor data of video cameras 713, 717, 721 may be transmitted to motor vehicle 501.

The raw environment sensor data may be processed for example, in particular evaluated, the processed or evaluated raw environment sensor data being transmitted to motor vehicle 501 as infrastructure data 733 for example.

For example, infrastructure 701, for example computer 709, may ascertain an environment model of a surroundings of motor vehicle 501 on the basis of the raw environment sensor data, and transmit this environment model as infrastructure data 733 to motor vehicle 501.

For example, computer 709 of local computer infrastructure 705 is able to ascertain a drive specification based on the raw environment sensor data, which motor vehicle 501 is to follow by driving in at least partially automated fashion. This drive specification may be transmitted as infrastructure data 733 to motor vehicle 501 via communication interface 711.

That is to say generally that infrastructure 701 is able to generate infrastructure data and transmit these to motor vehicle 501 so that motor vehicle 501 is able to use these infrastructure data 733.

For example, if infrastructure data 733 comprise environment sensor data, for example environment sensor raw data, motor vehicle 501 may use these environment sensor data exactly like environment sensor data of the environment sensors belonging to the motor vehicle.

That is to say that motor vehicle 501 treats these infrastructure data exactly in the same manner as the environment sensor data of the environment sensors belonging to the motor vehicle.

For this to be admissible, there is a provision to check in advance whether at least one safety condition is fulfilled.

If this is the case, the infrastructure data may be used directly for ascertaining corresponding control commands for safely controlling a lateral and/or longitudinal guidance of the motor vehicle.

Directly in this case means in particular that in such a case it is not necessary to perform and/or carry out at least one securing step for ensuring that it is possible to control the lateral and/or longitudinal guidance of the motor vehicle safely on the basis of the control commands.

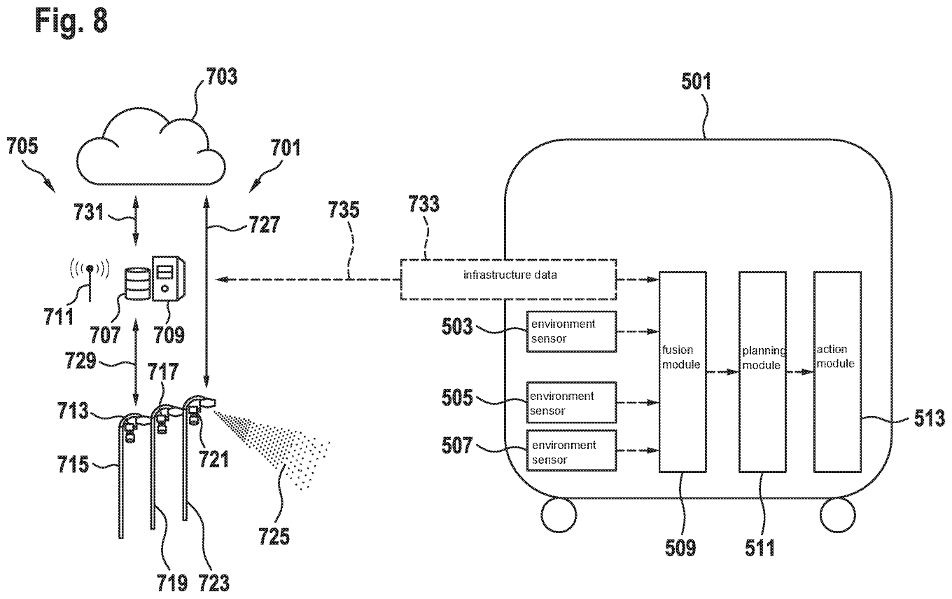

That is to say that in such a case, the infrastructure environment sensors are treated like environment sensors belonging to the motor vehicle, it being assumed that the individual environment sensors fulfill certain safety conditions, which is indicated, in analogy to FIG. 5, by the square 515 having rounded corners. FIG. 8 shows this symbolically in that the square, which is to symbolize infrastructure data 733, is drawn partially in the motor vehicle.

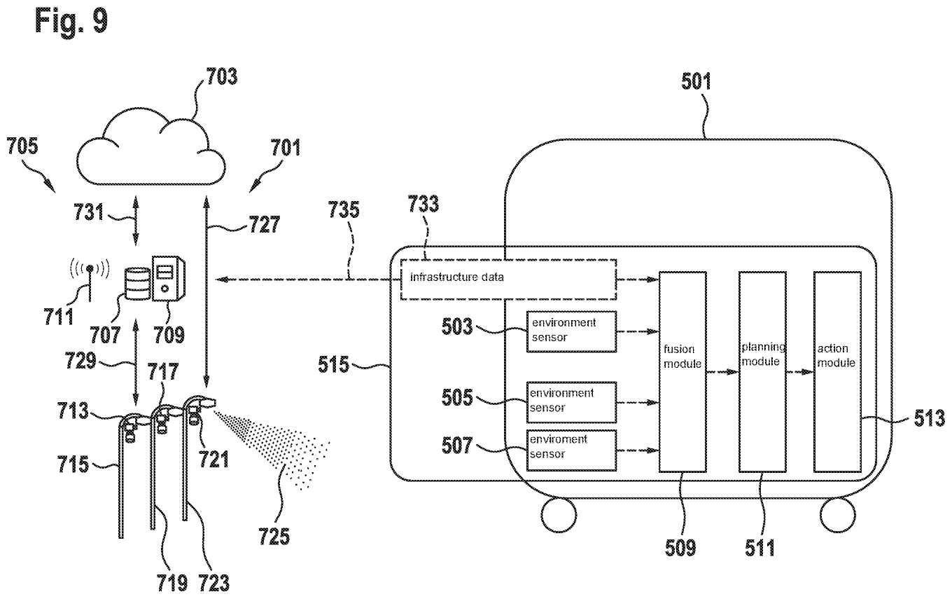

FIG. 9 symbolically shows the case in which the individual elements fulfill specific safety conditions. Thus, square 515 is again drawn for the purpose, square 515 comprising infrastructure data 733.

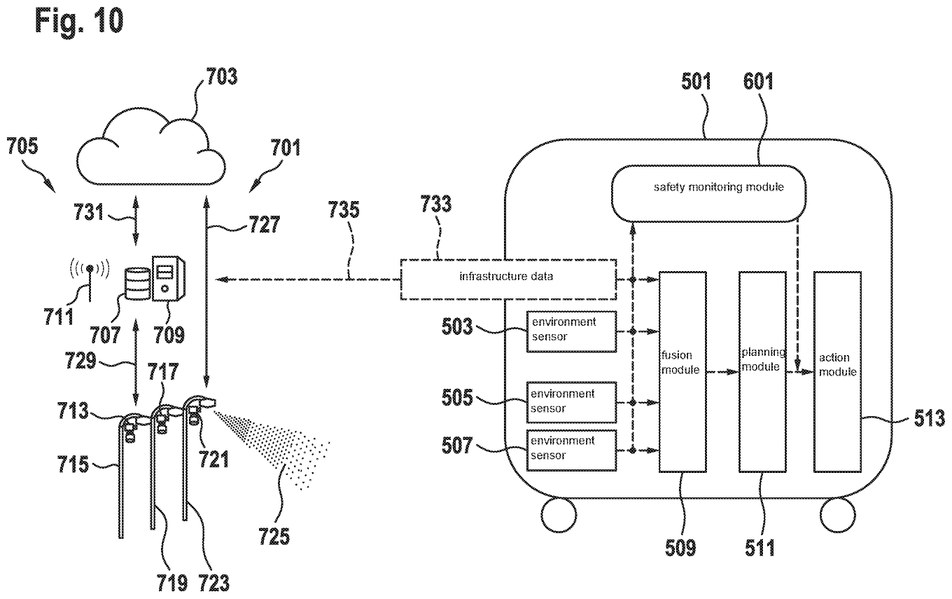

If the individual elements do not fulfill certain safety conditions, however, a safety monitoring module 601 may be provided in analogy to FIG. 6, which is shown symbolically in FIG. 10.

Infrastructure data 733 may comprise for example a drive specification, which motor vehicle 501 is to implement and/or drive.

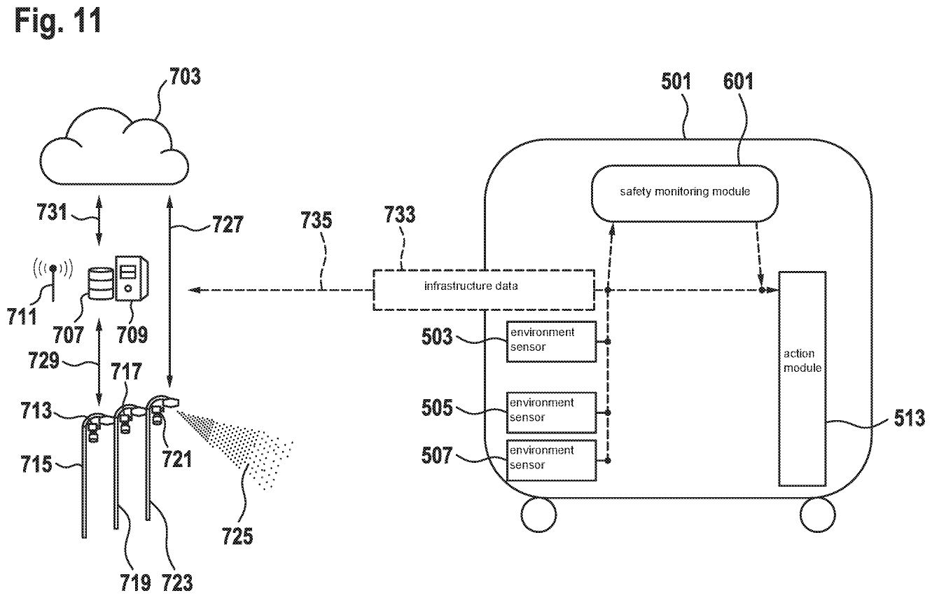

In such a case, it is no longer necessary for fusion module 509 and planning module 511 to perform the respective steps. That is to say that in such a case the drive specification of infrastructure 701 is provided directly to action module 513, which generates the appropriate control commands on this basis, which is shown symbolically in FIG. 11. According to one specific embodiment, the drive specification, which was ascertained by infrastructure 701 and which was specified to motor vehicle 501, may be checked by safety monitoring module 601 using data generated within the motor vehicle and/or at least one algorithm provided within the motor vehicle to determine whether the drive specification is safe, the control commands being ascertained as a function of a result of the check as to whether the drive specification is safe.

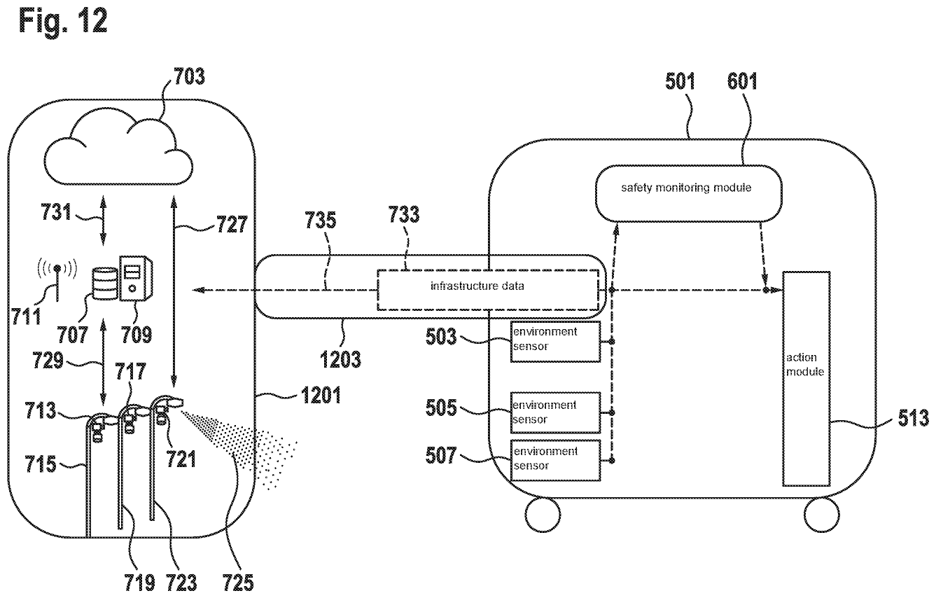

FIG. 12 shows symbolically that infrastructure 701 and a communication link between infrastructure 701 and motor vehicle 501 are checked to determine whether they are safe, that is, whether for them at least one safety condition is fulfilled. That is to say in particular that the individual elements of infrastructure 701, which are located within square 1201 having rounded corners, are checked to determine whether they fulfill specific safety conditions. That is to say in particular that the communication link, which is symbolically represented by square 1203 having rounded corners, is checked to determine whether it fulfills specific safety conditions, for example a predetermined minimum latency. According to one specific embodiment, the drive specification, which was ascertained by infrastructure 701 and which was specified to motor vehicle 501, may be checked by safety monitoring module 601 using data generated within the motor vehicle and/or at least one algorithm provided within the motor vehicle to determine whether the drive specification is safe, the control commands being ascertained as a function of a result of the check as to whether the drive specification is safe.

In such a case, that is, when the safety conditions are fulfilled, it may then be assumed that motor vehicle 501 is safely able to use infrastructure data 733.

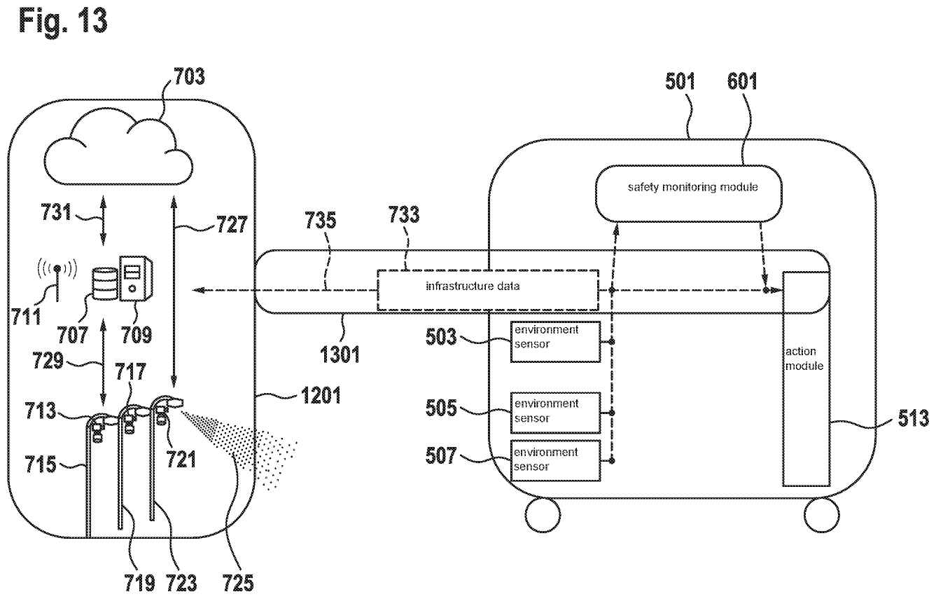

Expanding on FIG. 12, FIG. 13 shows that elements within motor vehicle 501 are also checked to determine whether they are safe, that is, whether they fulfill specific safety conditions.

This is indicated symbolically by a square 1301 that is expanded compared to square 1201 from FIG. 12, which thus also comprises a processing path of infrastructure data 733 within motor vehicle 501.

One specific embodiment of the present invention provides for the device to check a drive specification only for a certain distance to determine whether it is safe. That is to say that if the drive specification should go over a first distance, then the safety check is performed only up to a second distance, this second distance being smaller than the first distance.

There is a provision, for example, to check the drive specification entirely to determine whether it may be driven safely.

In summary, the present invention makes it possible to ensure that, when a motor vehicle is driven in at least partially automated fashion, that the at least partially automated driving of the motor vehicle is safe, that is, in the sense of the description “safe” and “secure”.

The present invention also includes that, if the infrastructure data comprise a drive specification, which the motor vehicle is to follow by driving in at least partially automated fashion, the drive specification is checked to determine whether it is safe by using data generated within the vehicle and/or by using at least one algorithm provided within the vehicle, the control commands being ascertained as a function of a result of the check determining whether the drive specification is safe.

The example embodiment is based inter alia in particular on analyzing how safe, that is, safe and secure, are the individual systems, that is, the individual components, that is, for example the motor vehicle, infrastructure traffic systems, infrastructure sensors, infrastructure computer systems (local, cloud) and communication.

In particular, an analysis is performed to determine the safety of the entire system or totality with respect to controlling the lateral and/or longitudinal guidance of the motor vehicle based on the infrastructure data.

Thus, in order to be permitted to control the lateral and/or longitudinal guidance of the motor vehicle based on the infrastructure data, the requirements of the individual systems and of the overall system must suffice for this purpose. For example, the individual systems and/or components and the overall system must exhibit a specific ASIL level according to the ASIL classification, for example ASIL-B.

One specific embodiment of the present invention provides for the step(s) of checking to be re-checked subsequently, that is, at a later point in time, for example regularly. For example, the step(s) of checking is/are re-checked subsequently at a predetermined frequency, for example every 100 ms.

This re-checking, that is, the re-checking to determine whether the at least one safety condition is fulfilled, occurs according to one specific embodiment prior to and/or after and/or during one or several predetermined method steps.

According to one specific embodiment of the present invention, the re-checking is performed or executed in the event of problems.

What is claimed is:

1. A method for driving a motor vehicle safely in at least partially automated fashion, comprising the following steps:
receiving infrastructure data signals, which represent infrastructure data generated by an infrastructure outside the motor vehicle;
receiving safety condition signals, which represent at least one safety condition for driving the motor vehicle in at least partially automated fashion based on the infrastructure data;
checking whether the at least one safety condition is fulfilled;
ascertaining control commands for safely controlling a lateral and/or longitudinal guidance of the motor vehicle based on the infrastructure data as a function of a result of the check whether the at least one safety condition is fulfilled, to drive the motor vehicle in at least partially automated fashion;
generating control signals, which represent the ascertained control commands; and
outputting the generated control signals.

2. The method as recited in claim 1, wherein, when the at least one safety condition is not fulfilled, the ascertaining of the control commands includes at least one securing step for ensuring that the lateral and/or longitudinal guidance of the motor vehicle may be controlled safely based on the control commands.

3. The method as recited in claim 2, wherein the at least one securing steps is respectively selected from the following group of securing steps: (i) redundant computing of data, (ii) diversitary computing of data, (iii) checking an operability of a redundant component for controlling the lateral and/or longitudinal guidance of the motor vehicle.

4. The method as recited in claim 1, wherein, when the infrastructure data include a drive specification, which the motor vehicle is to follow by driving in at least partially automated fashion, the drive specification is checked to determine whether it is safe by using data generated within the vehicle and/or by using at least one algorithm provided within the vehicle, the control commands being ascertained as a function of a result of the check determining whether the drive specification is safe.

5. The method as recited in claim 4, wherein, when the infrastructure data includes further data in addition to the drive specification, the further data being environment sensor data of at least one infrastructure environment sensor, the check whether the drive specification is safe is performed additionally based on the further data.

6. The method as recited in claim 1, wherein the at least one safety condition is respectively an element selected from the following group of safety conditions:
existence of a confirmation of the infrastructure that the infrastructure data are safe;
existence of a predefined safety integrity level or automotive safety integrity level of at least the motor vehicle and the infrastructure, including a communication link and/or communication components;
existence of a maximum latency of a communication between the motor vehicle and the infrastructure;
existence of a predetermined computer protection level of a device for performing the steps of the method;
existence of predetermined components and/or algorithms and/or communication options that are used for performing the steps of the method;
existence of a redundancy and/or diversity in predetermined components and/or algorithms and/or communication options that are used for performing the steps of the method;
existence of predetermined availability information, which indicates an availability of predetermined components and/or algorithms and/or communication options,
existence of predetermined quality criteria of the predetermined components and/or algorithms and/or communication options;
existence of a plan which includes measures for reducing errors and/or measures in the event of failures of predetermined components and/or algorithms and/or communication options and/or measures for fault analyses and/or measures in the event of misinterpretations;
existence of one or multiple fallback scenarios;
existence of a predetermined function;
existence of a predetermined traffic situation;
existence of a predetermined weather;
existence of maximally possible time for a respective implementation or execution of one or more steps of the method;
existence of a result of a check to determine that elements and/or functions, which are used for carrying out the method, currently function in a faultless manner.

7. The method as recited in claim 1, wherein a control of the lateral and/or longitudinal guidance of the motor vehicle based on the output control signals is monitored in that the step of checking whether the at least one safety condition is fulfilled is performed anew, the control of the lateral and/or longitudinal guidance of the motor vehicle based on the output control signals being continued to be executed as a function of a new result with respect to whether the at least one safety condition is fulfilled.

8. The method as recited in claim 1, wherein one or more of the method steps are performed within the motor vehicle and/or one or more of the method steps are performed outside the motor vehicle in the infrastructure.

9. The method as recited in claim 8, wherein the infrastructure is a cloud infrastructure.

10. The method as recited in claim 1, wherein the infrastructure data include one or several elements selected from the following group of data:
(i) environment sensor data of an infrastructure environment sensor,
(ii) surroundings data, which represent a surroundings of the motor vehicle,
(iii) weather data, which represent a weather in the surroundings of the motor vehicle,
(iv) traffic data, which represent a traffic in the surroundings of the motor vehicle,
(v) hazard data, which represent a location and/or a type of a hazard area in the surroundings of the motor vehicle,
(vi) road user state data, which represent a state of a road user in the surroundings of the motor vehicle,
(vii) drive specification which the motor vehicle is to follow by driving in at least partially automated fashion.

11. A device configured to drive a motor vehicle safely in at least partially automated fashion, the device configured to:
receive infrastructure data signals, which represent infrastructure data generated by an infrastructure outside the motor vehicle;
receive safety condition signals, which represent at least one safety condition for driving the motor vehicle in at least partially automated fashion based on the infrastructure data;
check whether the at least one safety condition is fulfilled;
ascertain control commands for safely controlling a lateral and/or longitudinal guidance of the motor vehicle based on the infrastructure data as a function of a result of the check whether the at least one safety condition is fulfilled, to drive the motor vehicle in at least partially automated fashion;
generate control signals, which represent the ascertained control commands; and
output the generated control signals.

12. A motor vehicle, comprising:
a device configured to drive the motor vehicle safely in at least partially automated fashion, device configured to:
receive infrastructure data signals, which represent infrastructure data generated by an infrastructure outside the motor vehicle;
receive safety condition signals, which represent at least one safety condition for driving the motor vehicle in at least partially automated fashion based on the infrastructure data;
check whether the at least one safety condition is fulfilled;
ascertain control commands for safely controlling a lateral and/or longitudinal guidance of the motor vehicle based on the infrastructure data as a function of a result of the check whether the at least one safety condition is fulfilled, to drive the motor vehicle in at least partially automated fashion;
generate control signals, which represent the ascertained control commands; and
output the generated control signals.

13. A non-transitory machine-readable storage medium on which is stored a computer program for driving a motor vehicle safely in at least partially automated fashion, the computer program, when executed by a computer, causing the computer to perform the following steps:
receiving infrastructure data signals, which represent infrastructure data generated by an infrastructure outside the motor vehicle;
receiving safety condition signals, which represent at least one safety condition for driving the motor vehicle in at least partially automated fashion based on the infrastructure data;
checking whether the at least one safety condition is fulfilled;
ascertaining control commands for safely controlling a lateral and/or longitudinal guidance of the motor vehicle based on the infrastructure data as a function of a result of the check whether the at least one safety condition is fulfilled, to drive the motor vehicle in at least partially automated fashion;
generating control signals, which represent the ascertained control commands; and
outputting the generated control signals.
